(19) United States
(12) Patent Application Publication
(10) Pub. No.: US 2017/0306180 A1
(43) Pub. Date: Oct. 26, 2017

(54) Special light saber blade coating and a process to make the same

(71) Applicant: Gavin Albright, Hornlake, MS (US)

(72) Inventor: Gavin Albright, Hornlake, MS (US)

(21) Appl. No.: 15/497,121

(22) Filed: Apr. 25, 2017

Related U.S. Application Data
(60) Provisional application No. 62/327,878, filed on Apr. 26, 2016.

(51) Int. Cl. C09D 179/02; C09D 163/04; C09D 1/00; C09D 5/22; C09D 5/03; C09D 171/12; C09D 163/00

(52) U.S. Cl. CPC C09D 179/02; C09D 171/12; C09D 163/04; C09D 163/00; C09D 5/22; C09D 5/03; C09D 1/00; A63H 33/009

(57) ABSTRACT

A special light saber blade coating and a process to make the coated blade which provides a replica sword as an authentic-looking device as seen in “Star Wars” movies, out-takes and re-enactments. The sword blade device provides a unique and realistic replica of the light saber. The process using epoxy, color glitter and other materials is a set of repetitive steps to place the mixture of epoxy onto the blade with a method that is economic and repeatable producing a light saber blade with quality and durability.

### CROSS-REFERENCE TO RELATED APPLICATIONS

This application claims the benefit of U.S. Provisional Patent Application with Ser. No. 62/327,878 filed Apr. 26, 2016, by Gavin Albright and entitled “A special light saber blade coating and a process to make the same”.

### FIELD OF INVENTION

This invention, a special light saber blade coating and a process to make the same, relates to a replica sword as an authentic-looking device as seen in “Star Wars” movies, out-takes and re-enactments. In particular, the sword blade device (and the method to produce) provide a unique and realistic replica of the light saber and a method to produce this device.

### FEDERALLY SPONSORED RESEARCH

None.

### SEQUENCE LISTING OR PROGRAM

None.

### BACKGROUND—FIELD OF INVENTION AND PRIOR ART

As far as known, there are no special light saber blade coating or processes to make the same or the like. It is believed that this device and process are unique in its design and technologies.

### Background

The phenomenal impact of Star Wars and spin-off movies continues to grow. In its acceptance in society, there are many games, costumes, genre remakes and other outgrowths from the original series and the continuing updates and expansions for the Star Wars theme. As a result, the desire for realistic items or replicas such as the light sabre have created a commercial opportunity to provide realistic and appropriate genre replica item—such as light sabers and the like.

### Problem Solved

Prior art has failed to address a realistic look to the light sabers available to the public as a commercial product. The improvement and problem solved as to providing realistic light sabers with various blade finishes including roughness, multi-color, and three dimensional coatings is the primary focus of this product. A simple, specific manufacturing process of economically and repeatability producing the product with quality and durability is the focus of the process.

### PRIOR ART

A novelty search was performed. All the prior art failed to address and solve the problem of the unique coating and process presented by this inventor Albright. The art included:

| Item | Patent | | | Year |
|---|---|---|---|---|
| No. | Number | Title | Inventor | Issued |
| 1 | DE20201300 | Illuminated Toy | German Patent | 2014 |
| | | Lightsaber | | |
| 2 | 7,611,398 | Toy Sword | Woodhouse | 2009 |
| 3 | 6,945,842 | Toy Sword With | Gulmesoff | 2005 |
| | | Contact Indicator | | |
| 4 | 6,641,280 | Hand-Holdable Toy | Hanson et al. | 2003 |
| | | Light Tube | | |
| 5 | 5,947,789 | Toy Sword Having | Chan | 1999 |
| | | A Variable Color | | |
| | | Illuminated Blade | | |
| 6 | 5,279,513 | Illuminated Toy | Connelly | 1994 |
| 7 | 4,678,450 | Toy Light Sword | Scoleri et al. | 1987 |

### SUMMARY OF THE INVENTION

This invention is a special light saber blade coating and a process to make the same for various applications. Taught here are the ways of the device and process to manufacture this special light saber.

The preferred embodiment of the device 30 is a special light saber blade coating comprised of: (a) Elite Crete Systems Reflector Enhancer (coloring pigment); (b) Elite Crete Systems E100-PT1 Crystal Clear epoxy (part a and b); (c) a manufactured poly carbonate light saber blade complete with light diffusion film; (d) a manufactured light saber hilt complete with light; and (e) glow in the dark pigment powder. The preferred embodiment of the process/method 60 is comprised of a special light saber blade coating process comprised of the following steps:
First (1): gathering a group of materials for the coating process;
Second (2): Mixing approximately ½ cup part A and approximately ¼ cup part B epoxy mixture together in a pour bucket and adding a desired and pre-determined amount of reflector enhancer and coloring agent, the epoxy mixture with a desired amount of enhancer and color agent can vary depending on the on the color outcome desired;
Third (3): Holding the poly carbonate blade vertically over a catch bucket and beginning to pour the mixed epoxy mixture over a poly carbonate blade;
Fourth (4): twisting and turning the blade to coat the surface of the blade thoroughly;
Fifth (5): As the pour bucket empties, continuing to hold the blade over the catch bucket vertically while lifting the catch bucket and pouring any of the excess runoff back into the pouring/mixing bucket for immediate re-use;
Sixth (6): Putting the catch bucket back down onto a flat surface such as a floor, bench, or table, and continuing to hold the blade vertically;
Seventh (7) Immediately reusing and pouring the excess mixture from the catch bucket down onto the blade again;
Eighth (8): Repeating the reusing of material from the catch bucket several times continuously (up to approximately 2 hours);
Ninth (9): Flipping the blade to the opposite vertical position until the epoxy begins to run down the blade to where the blade is pre-marked and gauged a stopping point;
Tenth (10): Returning the blade to the previous vertical position until the epoxy tries to drip off of the tip;
Eleventh (11): Flipping blade vertically again;
Twelfth (12): Holding the blade horizontal at times and spinning/rolling the blade to secure a more solid coat and to evenly disperse the color;
Thirteenth (13): Brushing the blade with a paint brush for texture;
Fourteenth (14): Plugging/attaching the blade into a light sabre hilt with a light and shining the light through an interior of the blade to confirm the even dispersal of the mixture and to check the consistency of the coating process;
Fifteenth (15): Curing in ambient or light heated the mixture;
Sixteenth (16): Repeating steps 1 through 13 with another blade as needed.

The newly invented special light saber blade coating and a process to make the same for various applications may be manufactured at low volumes by very simple means and in high volume production by more complex and controlled systems.

### OBJECTS AND ADVANTAGES

There are several objects and advantages of the special light saber blade coating and a process to make the same. There are currently no known special light saber blade coating and process to make that are effective at providing the objects of this invention.

The special light saber blade coating and a process to make the same have various advantages and benefits (Table A):

| Item | Advantages |
|---|---|
| 1 | Provides improved light saber colors |
| 2 | Provides light saber textures |
| 3 | Utilizes existing technologies |
| 4 | Provides a large array of options to the |
| | consumer |

Finally, other advantages and additional features of the present special light saber blade coating and a process to make the same will be more apparent from the accompanying drawings and from the full description of the device. For one skilled in the art of making replicas and providing special coating, it is readily understood that the features shown in the examples with this product are readily adapted to other types of out sword and Star Wars genre objects systems and devices.

### DESCRIPTION OF THE DRAWINGS

### Figures

The accompanying drawings, which are incorporated in and constitute a part of this specification, illustrate an embodiment of the special light saber blade coating and a process to make the same that is preferred. The drawings together with the summary description given above and a detailed description given below serve to explain the principles of the special light saber blade coating and a process to make the same. It is understood, however, that the special light saber blade coating and a process to make the same are not limited to only the precise arrangements and instrumentalities shown.

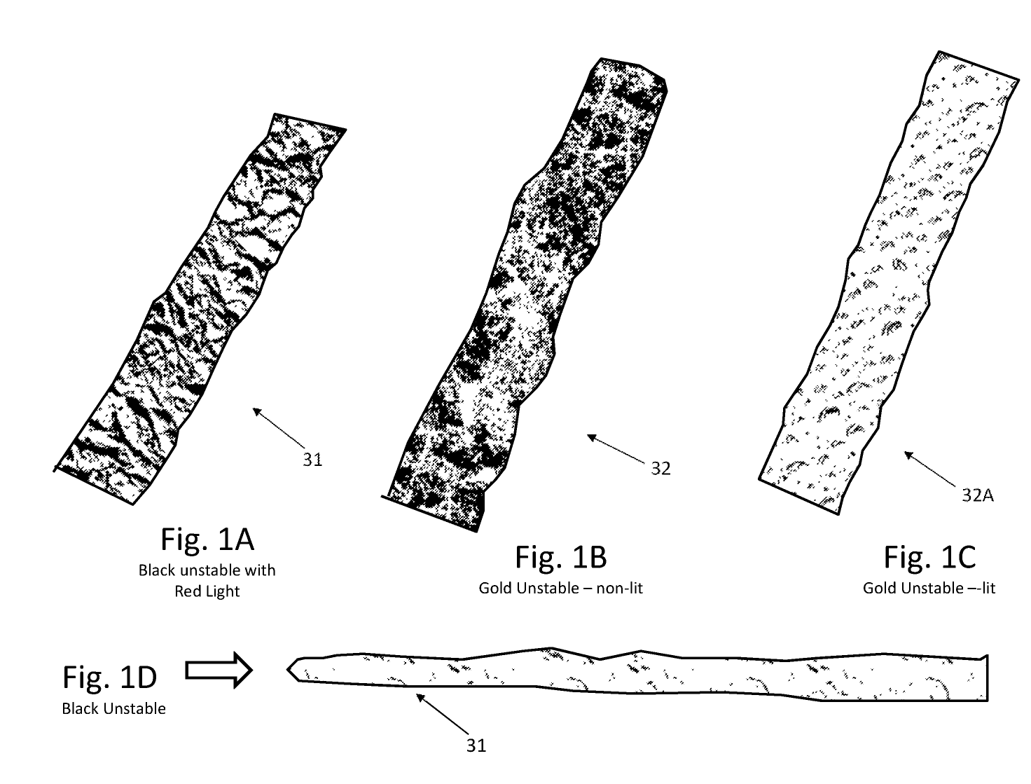

FIGS. 1 A through 1 D are sketches of the general light saber blade device 30A.

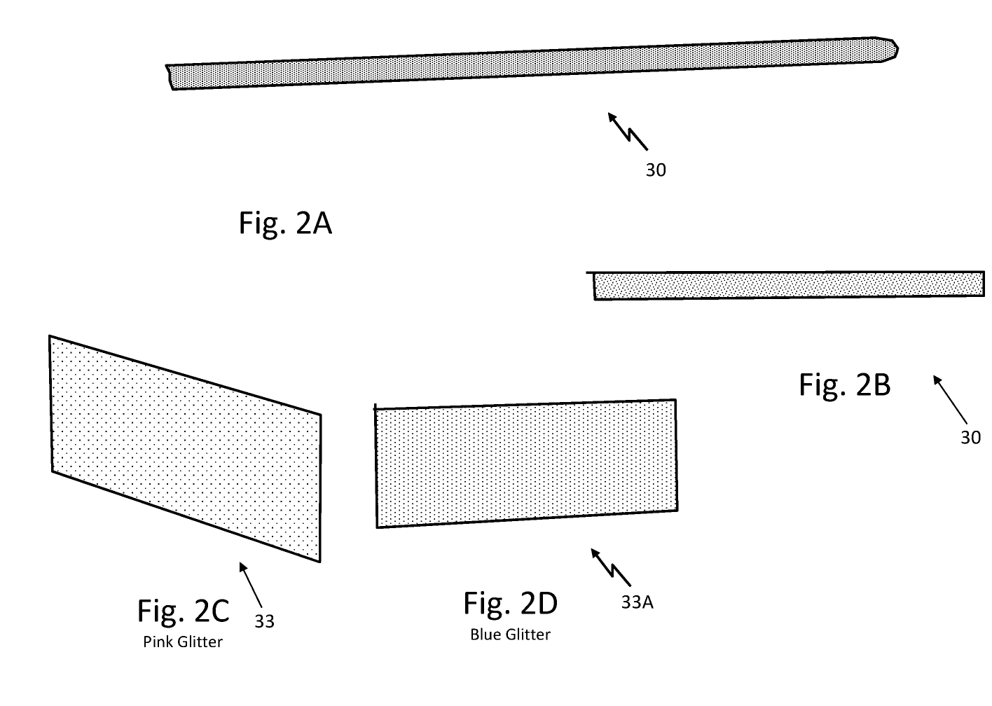

FIGS. 2 A through 2 D are sketches of the general light saber device with components and special coatings noted.

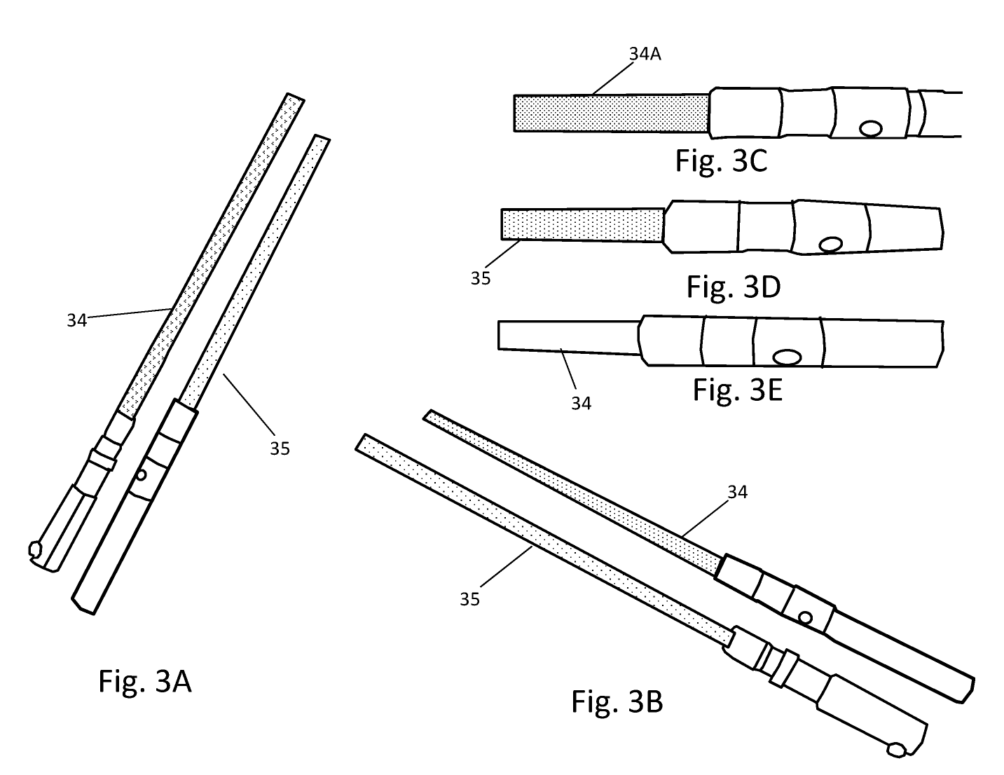

FIG. 3 A through 3 E are sketches of more light saber devices with the components and features shown.

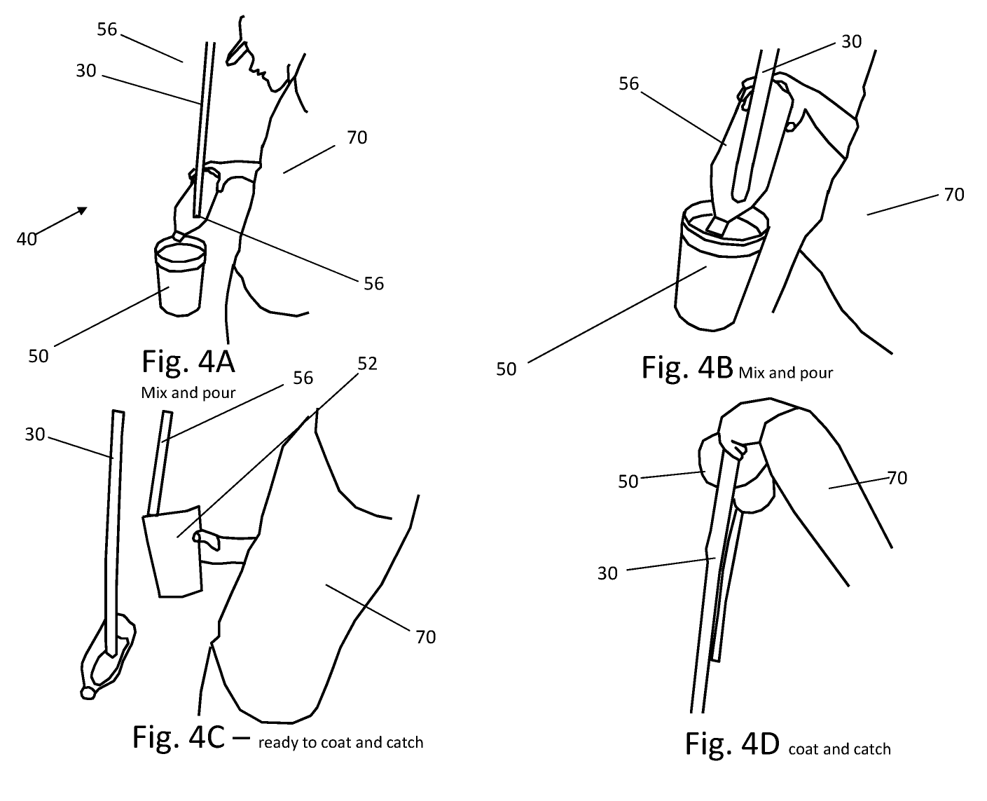

FIGS. 4 A through 4 D are sketches of the method to produce the special light saber device.

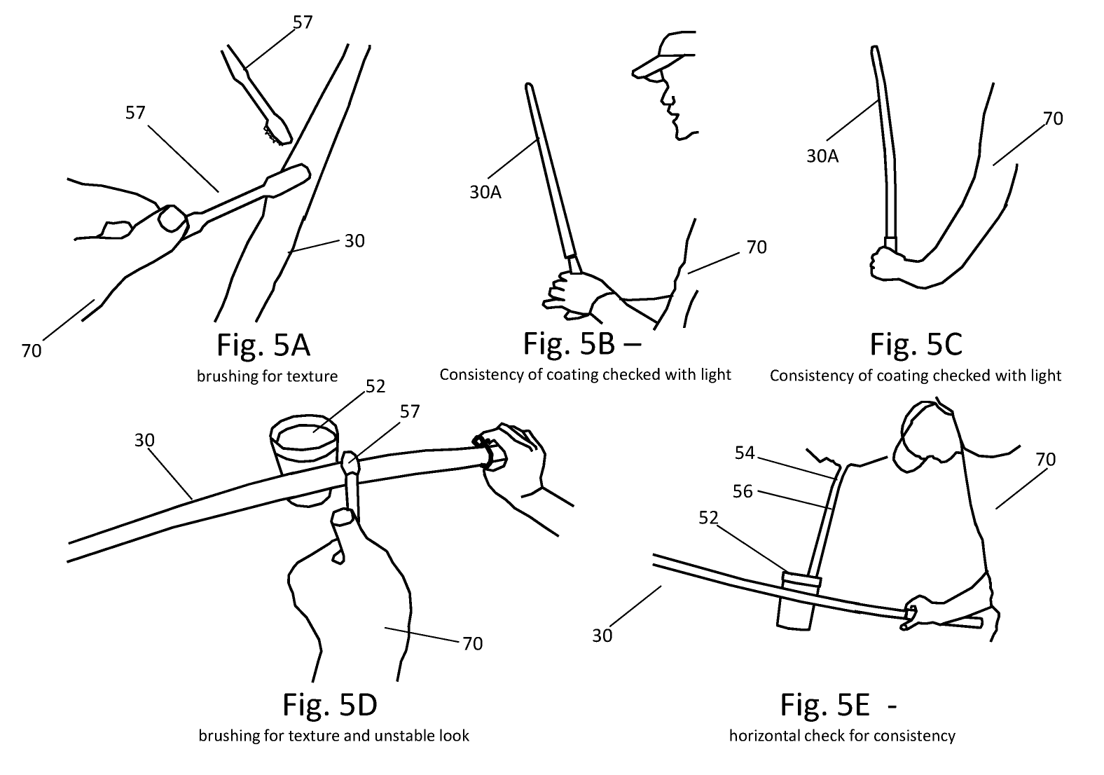

FIGS. 5 A through 5 E are more sketches of the method to produce the special light saber device as shown.

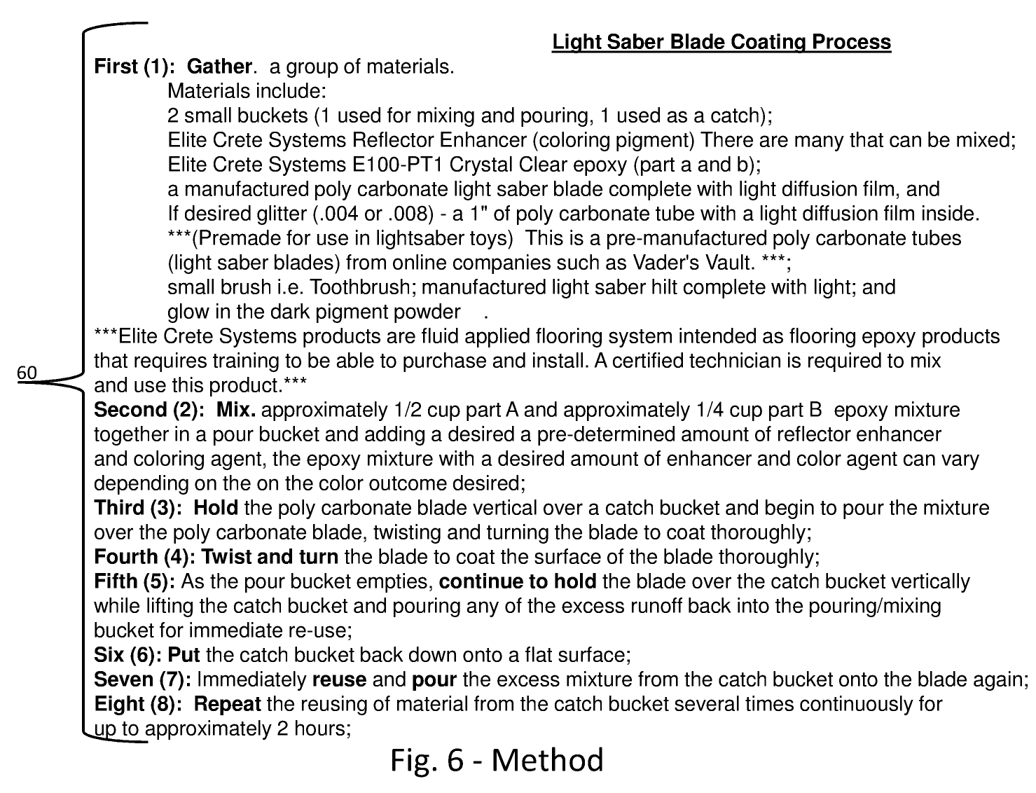

FIG. 6 is a listing of the method to produce the special light saber device.

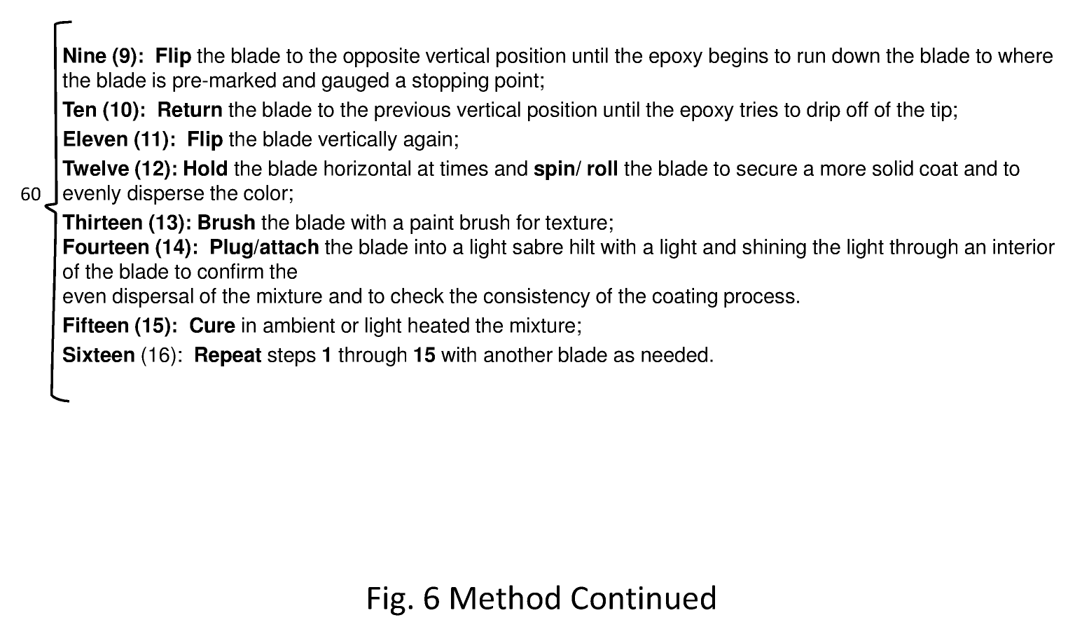

FIG. 7 are options in the production of the light saber device.

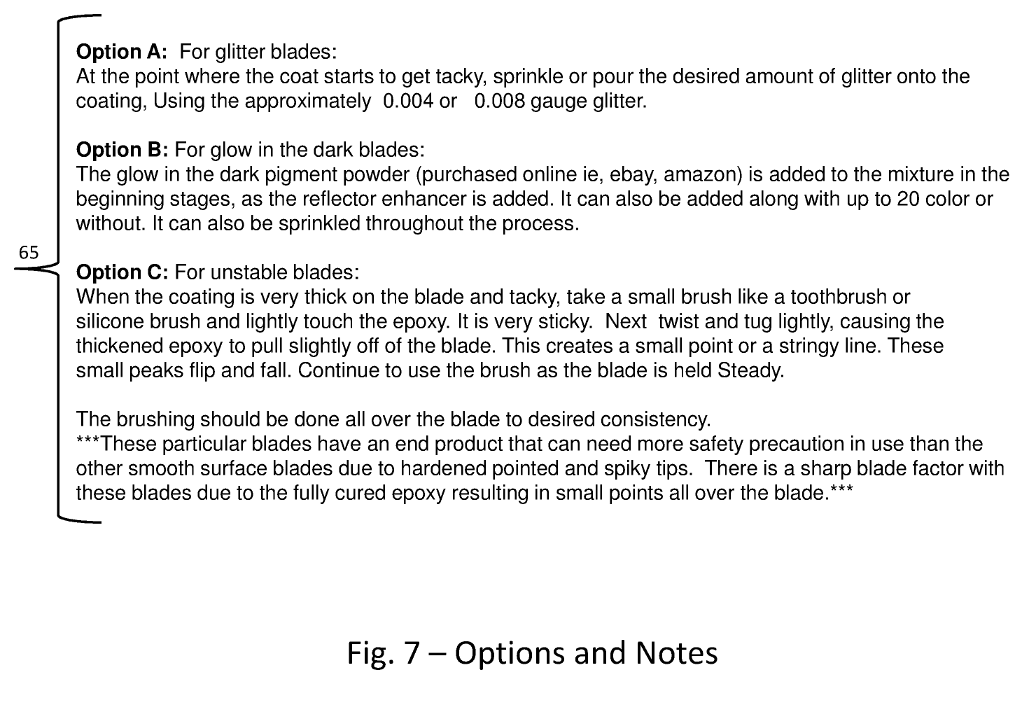

FIGS. 8A through 8D are sketches of prior art for light sabers and similar devices.

### DESCRIPTION OF THE DRAWINGS

### Reference Numerals

The following list refers to the drawings:

TABLE B
Reference numbers

| Ref # | Description |
|---|---|
| 30 | General light saber device 30 with various |
| | surface finishes |
| 30A | Lighted saber 30A |
| 31 | Black, unstable surface with red light 31 |
| 32 | Gold, unstable surface finish 32 |
| 32A | Gold, unstable surface finish—Lit 32A |
| 33 | General light saber 30 with pink glitter 33 |
| 33A | General light saber 30 with blue glitter 33A |
| 34 | Lighted general light saber 34 |
| 34A | Lighted saber with glitter 34A |
| 35 | Un-lit general light saber 35 |
| 40 | Mixture step “mix and pour” 40 |
| 50 | Mix and pour bucket 50 |
| 52 | Catch bucket 52 |
| 54 | Pour stream 54 |
| 56 | Mixture/material 56 |
| 57 | Application brush 57 |
| 60 | Method of application 60 |
| 65 | Options 65 for application |
| 70 | Operator 70 |
| 85 | Prior Art 85—U.S. Pat. No. 4,678,450 by Scolari et al. |
| 86 | Prior Art 86—U.S. Pat. No. 7,611,398 by Woodhouse. |
| 87 | Prior Art 87—U.S. Pat. No. 5,947,789 by Chan. |
| 88 | Prior Art 88—U.S. Pat. No. 6,641,280 by Hanson et al. |

### DETAILED DESCRIPTION OF PREFERRED EMBODIMENT

The present development is a special light saber blade coating and a process to make the same. This invention relates to a replica sword as an authentic-looking device as seen in “Star Wars” movies, out-takes and re-enactments. In particular, the sword blade device (and the method to produce) provide a unique and realistic replica of the light saber and a method to produce this device.

The advantages for the special light saber blade coating and a process to make the same are listed above in the introduction. Succinctly the benefits are that the device and process that it/they:
1. Provide improved light saber colors
2. Provide light saber textures
3. Utilize existing technologies
4. Provide a large array of options to the consumer

The preferred embodiment of the device 30 is a special light saber blade coating comprised of: (a) Elite Crete Systems Reflector Enhancer (coloring pigment); (b) Elite Crete Systems E100-PT1 Crystal Clear epoxy (part a and b); (c) a manufactured poly carbonate light saber blade complete with light diffusion film; (d) a manufactured light saber hilt complete with light; and (e) glow in the dark pigment powder.

The preferred embodiment of the process/method 60 is comprised of a special light saber blade coating process comprised of the following steps:
First (1): gathering a group of materials for the coating process;
Second (2): Mixing approximately ½ cup part A and approximately ¼ cup part B epoxy mixture together in a pour bucket and adding a desired and pre-determined amount of reflector enhancer and coloring agent, the epoxy mixture with a desired amount of enhancer and color agent can vary depending on the on the color outcome desired;
Third (3): Holding the poly carbonate blade vertically over a catch bucket and beginning to pour the mixed epoxy mixture over a poly carbonate blade;
Fourth (4): twisting and turning the blade to coat the surface of the blade thoroughly;
Fifth (5): As the pour bucket empties, continuing to hold the blade over the catch bucket vertically while lifting the catch bucket and pouring any of the excess runoff back into the pouring/mixing bucket for immediate re-use;
Sixth (6): Putting the catch bucket back down onto a flat surface such as a floor, bench, or table, and continuing to hold the blade vertically;
Seventh (7) Immediately reusing and pouring the excess mixture from the catch bucket down onto the blade again;
Eighth (8): Repeating the reusing of material from the catch bucket several times continuously (up to approximately 2 hours);
Ninth (9): Flipping the blade to the opposite vertical position until the epoxy begins to run down the blade to where the blade is pre-marked and gauged a stopping point;
Tenth (10): Returning the blade to the previous vertical position until the epoxy tries to drip off of the tip;
Eleventh (11): Flipping blade vertically again;
Twelfth (12): Holding the blade horizontal at times and spinning/rolling the blade to secure a more solid coat and to evenly disperse the color;
Thirteenth (13): Brushing the blade with a paint brush for texture;
Fourteenth (14): Plugging/attaching the blade into a light sabre hilt with a light and shining the light through an interior of the blade to confirm the even dispersal of the mixture and to check the consistency of the coating process;
Fifteenth (15): Curing in ambient or light heated the mixture;
Sixteenth (16): Repeating steps 1 through 13 with another blade as needed.

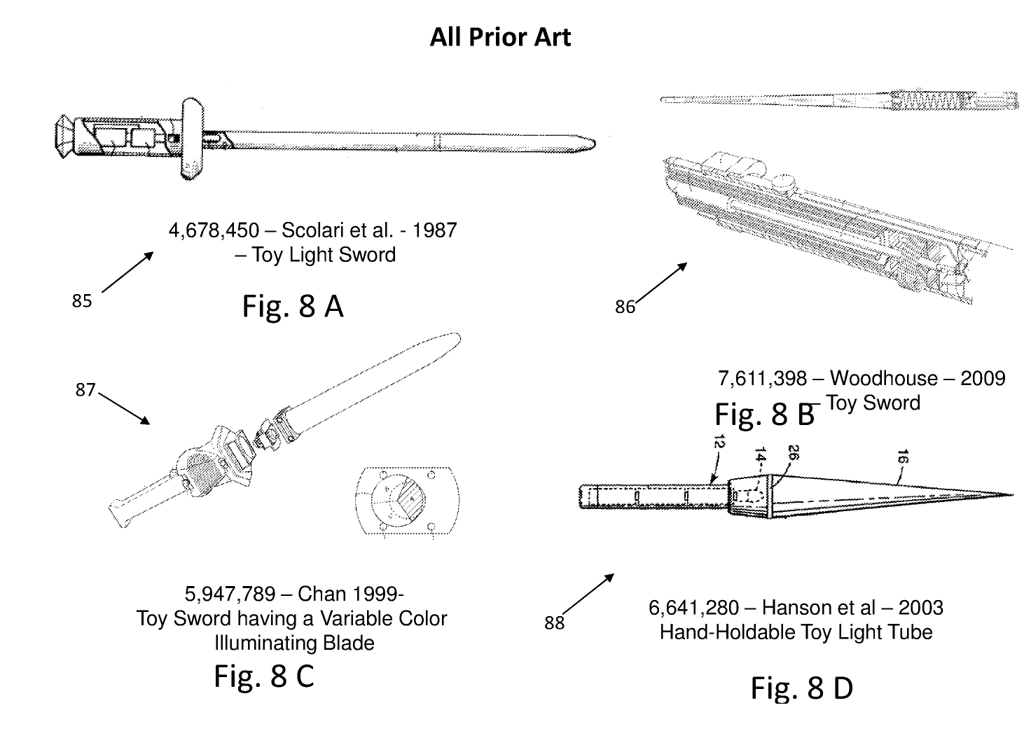

There is shown in FIGS. 1-9 a complete description and operative embodiment of the special light saber blade coating and a process to make the same. In the drawings and illustrations, one notes well that the FIGS. 1-9 demonstrate the general configuration and use of this product. The various example uses are in the operation and use section, below.

The accompanying drawings, which are incorporated in and constitute a part of this specification, illustrate an embodiment of the special light saber blade coating and a process to make the same that is preferred. The drawings together with the summary description given above and a detailed description given below serve to explain the principles of the special light saber blade coating and a process to make the same. It is understood, however, that the special light saber blade coating and a process to make the same is not limited to only the precise arrangements and instrumentalities shown. Other examples of toy and replica device coatings and methods are still understood by one skilled in the art producing replica devices and methods therein to be within the scope and spirit shown here.

FIGS. 1 A through 1 D are sketches of the general light saber blade device and method. Demonstrated here are a black, unstable surface on the saber with red light 31; a gold, unstable surface finish 32 on the saber; and a gold, unstable surface finish—Lit 32A.

FIGS. 2 A through 2 D are sketches of the general light saber device with components and special coatings noted. Provided in these sketches are: a general light saber device 30 with various coatings and surface finishes; a general light saber 30 with pink glitter 33; and a general light saber 30 with blue glitter 33A. One notes that currently there are over twenty standard colors available including, but not limited to: black, white, green, red, silver, gold, purple, amber, yellow, orange, blue, cyan, chartreuse green, magenta, rose, red-orange, and violet.

FIG. 3 A through 3 E are sketches of more light saber devices with the components and features shown. Shown and demonstrated here are: a lighted general light saber 34; a lighted saber with glitter 34A; and an un-lit general light saber 35.

FIGS. 4 A through 4 D are sketches of the method to produce the special light saber device. FIGS. 5 A through 5 E are more sketches of the method to produce the special light saber device as shown. FIG. 6 is a listing of the method to produce the special light saber device. FIG. 7 are options in the production of the light saber device. All these FIG. 4 A through FIG. 7 are shown below in the operations section.

FIGS. 8A through 8D are sketches of prior art for light sabers and similar devices. In this drawing are shown prior art objects: prior Art 85—U.S. Pat. No. 4,678,450 by Scolari et al.—1987 “Toy Light Sword”; prior Art 86—U.S. Pat. No. 7,611,398 by Woodhouse—2009—“Toy Sword”; prior Art 87—U.S. Pat. No. 5,947,789 by Chan—1999—“Toy Sword having a Variable Color Illuminating Blade”; and prior Art 88—U.S. Pat. No. 6,641,280 by Hanson et al.—2003—“Hand-Holdable Toy Light Tube”.

The details mentioned here are exemplary and not limiting. Other specific components and manners specific to describing the special light saber blade coating 30 and a process/method 60 may be added as a person having ordinary skill in the field of the art of coating and epoxy processes their uses well appreciates.

### Operation of the Preferred Embodiment

The special light saber blade coating 30 and a process/method to make 60 the same has been described in the above embodiment. The manner of how the process to fabricate the light saber is described below. One notes well that the description above and the process and method 60 described here must be taken together to fully illustrate the concept of the special light saber blade coating 30 and a process/method 60 to make the same. The preferred embodiment of the device 30 is a special light saber blade coating comprised of: (a) Elite Crete Systems Reflector Enhancer (coloring pigment); (b) Elite Crete Systems E100-PT1 Crystal Clear epoxy (part a and b); (c) a manufactured poly carbonate light saber blade complete with light diffusion film; (d) a manufactured light saber hilt complete with light; and (e) glow in the dark pigment powder.

The preferred embodiment of the process/method 60 is comprised of a special light saber blade coating process comprised of the following steps:
First (1): gathering a group of materials for the coating process;
Second (2): Mixing approximately ½ cup part A and approximately ¼ cup part B epoxy mixture together in a pour bucket and adding a desired and pre-determined amount of reflector enhancer and coloring agent, the epoxy mixture with a desired amount of enhancer and color agent can vary depending on the on the color outcome desired;
Third (3): Holding the poly carbonate blade vertically over a catch bucket and beginning to pour the mixed epoxy mixture over a poly carbonate blade;
Fourth (4): twisting and turning the blade to coat the surface of the blade thoroughly;
Fifth (5): As the pour bucket empties, continuing to hold the blade over the catch bucket vertically while lifting the catch bucket and pouring any of the excess runoff back into the pouring/mixing bucket for immediate re-use;
Sixth (6): Putting the catch bucket back down onto a flat surface such as a floor, bench, or table, and continuing to hold the blade vertically
Seventh (7) Immediately reusing and pouring the excess mixture from the catch bucket down onto the blade again;
Eighth (8): Repeating the reusing of material from the catch bucket several times continuously (up to approximately 2 hours);
Ninth (9): Flipping the blade to the opposite vertical position until the epoxy begins to run down the blade to where the blade is pre-marked and gauged a stopping point;
Tenth (10): Returning the blade to the previous vertical position until the epoxy tries to drip off of the tip;
Eleventh (11): Flipping blade vertically again;
Twelfth (12): Holding the blade horizontal at times and spinning/rolling the blade to secure a more solid coat and to evenly disperse the color;
Thirteenth (13): Brushing the blade with a paint brush for texture;
Fourteenth (14): Plugging/attaching the blade into a light sabre hilt with a light and shining the light through an interior of the blade to confirm the even dispersal of the mixture and to check the consistency of the coating process.
Fifteenth (15): Curing in ambient or light heated the mixture;
Sixteenth (16): Repeating steps 1 through 13 with another blade as needed.

FIGS. 4 A through 4 D are sketches of the method to produce the special light saber device. Provided in these sketches are: a general light saber device 30 with various coatings and surface finishes; a mixture step “mix and pour” 40; a mix and pour bucket 50; a catch bucket 52; mixture/material 56; and an operator 70.

FIGS. 5 A through 5 E are more sketches of the method to produce the special light saber device as shown. These drawings and sketches show: general light saber device 30 with various coatings and surface finishes; a lighted saber 30A; the catch bucket 52; the pour stream 54; a mixture/material 56; an application brush 57; and an operator/operator's hand 70.

FIG. 6 is a listing of the method to produce the special light saber device. Here is shown the Light Saber Blade Coating Process 60:
First (1): Gather. a group of materials.
   Materials include:
      2 small buckets (1 used for mixing and pouring, 1 used as a catch); Elite Crete Systems Reflector Enhancer (coloring pigment) There are many that can be mixed; Elite Crete Systems E100-PT1 Crystal Clear epoxy (part a and b); a manufactured poly carbonate light saber blade complete with light diffusion film, and if desired, a glitter (0.004 or 0.008 gauge)—a 1″ of poly carbonate tube with a light diffusion film inside. ***(Premade for use in lightsaber toys) This is a pre-manufactured poly carbonate tubes (light saber blades) from online companies such as Vader's Vault. ***; small brush i.e. Toothbrush; manufactured light saber hilt complete with light; and low in the dark pigment powder; ***Elite Crete Systems products are fluid applied flooring system intended as flooring epoxy products that requires training to be able to purchase and install. A certified technician is required to mix and use this product.***
Second (2): Mix. approximately ½ cup part A and approximately ¼ cup part B epoxy mixture together in a pour bucket and adding a desired a pre-determined amount of reflector enhancer and coloring agent, the epoxy mixture with a desired amount of enhancer and color agent can vary depending on the on the color outcome desired;
Third (3): Hold the poly carbonate blade vertical over a catch bucket and begin to pour the mixture over the poly carbonate blade, twisting and turning the blade to coat thoroughly;
Four (4): Twist and turn the blade to coat the surface of the blade thoroughly;
Five (5): As the pour bucket empties, continue to hold the blade over the catch bucket vertically while lifting the catch bucket and pouring any of the excess runoff back into the pouring/mixing bucket for immediate re-use;
Six (6): Put the catch bucket back down onto a flat surface;
Seven (7): Immediately reuse and pour the excess mixture from the catch bucket onto the blade again;
Eight (8): Repeat the reusing of material from the catch bucket several times continuously for up to approximately 2 hours;
Nine (9): Flip the blade to the opposite vertical position until the epoxy begins to run down the blade to where the blade is pre-marked and gauged a stopping point;
Ten (10): Return the blade to the previous vertical position until the epoxy tries to drip off of the tip;
Eleven (11): Flip the blade vertically again;
Twelve (12): Hold the blade horizontal at times and spin/roll the blade to secure a more solid coat and to evenly disperse the color;
Thirteen (13): Brush the blade with a paint brush for texture;
Fourteen (14): Plug/attach the blade into a light sabre hilt with a light and shining the light through an interior of the blade to confirm the even dispersal of the mixture and to check the consistency of the coating process.
Fifteen (15): Cure in ambient or light heated the mixture;
Sixteen (16): Repeat steps 1 through 15 with another blade as needed.
   The curing can be in ambient air or a heated vessel such as an oven which has a continuous airflow or heated by resistance heating, infrared, electric or gas forced air, or the like.

FIG. 7 are options in the production of the light saber device. Many types and options are anticipated for the special light saber blade coating 30 depending on the materials and method 60. Some examples, and not limitations, are shown in the following Table C.

| Option | Purpose | DESCRIPTION |
|---|---|---|
| A | For glitter | At the point where the coat starts |
| | blades | to get tacky, sprinkle or pour the |
| | | desired amount of glitter onto the |
| | | coating, |
| | | Using the approximately 0.004 or |
| | | 0.008 gauge glitter. |
| B | For glow in | The glow in the dark pigment powder |
| | the dark | (purchased online i.e., eBay, |
| | blades | amazon) is added to the mixture in |
| | | the beginning stages, as the |
| | | reflector enhancer is added. It can |
| | | also be added along with color or |
| | | without. It can also be sprinkled |
| | | throughout the process. |
| C | For | When the coating is very thick on |
| | unstable | the blade and tacky, take a small |
| | blades | brush like a toothbrush or silicone |
| | | brush and lightly touch the epoxy. |
| | | It is very sticky. Next one twists |
| | | and tugs lightly, causing the |
| | | thickened epoxy to pull slightly off |
| | | of the blade. This creates a small |
| | | point or a stringy line. These small |
| | | peaks flip and fall. Continue to use |
| | | the brush as the blade is held |

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

With this description it is to be understood that the special light saber blade coating 30 and a process/method 60 to make the coated saber are not to be limited to only the disclosed embodiment of product and process. The features and options of special light saber blade coating 30 and a process/method 60 are intended to cover various modifications and equivalent arrangements included within the spirit and scope of the description.

What is claimed is:

1. A special light saber blade coating comprised of:
(a) an Elite Crete Systems Reflector Enhancer (coloring pigment);
(b) an Elite Crete Systems E100-PT1 Crystal Clear epoxy (equal parts a and b); and
(c) a pigment powder that glows in the dark
wherein the light saber blade coating is applied to an exterior surface of a manufactured poly carbonate light saber blade complete with a light diffusion film and the coated blade assembled to a saber hilt complete with a light source to produce a realistic “Star Wars” replica light saber.

2. The coating according to claim 1 wherein the coloring pigment can be from at least twenty different colors.

3. The coating according to claim 2 wherein the colors are selected from a group consisting of black, white, green, red, silver, gold, purple, amber, yellow, orange, blue, cyan, chartreuse green, magenta, rose, red-orange, and violet.

4. The coating according to claim 1 further comprised of glitter.

5. The coating according to claim 1 further comprised of a brushed textured surface.

6. The coating according to claim 1 further comprised of a brushed surface with a series of small points and a stringy peak of coating material.

7. A special light saber blade coating process (60) comprised of the following steps:
(a) gathering a group of materials for the coating process; (b) Mixing approximately ½ cup part A and approximately ¼ cup part B epoxy mixture together in a pour bucket; (c) Holding the poly carbonate blade vertically over a catch bucket and beginning to pour the mixed epoxy mixture over a poly carbonate blade; (d) twisting and turning the blade to coat the surface of the blade thoroughly;
(e) As the pour bucket empties, continuing to hold the blade over the catch bucket vertically while lifting the catch bucket and pouring any of the excess runoff back into the pouring/mixing bucket for immediate re-use; (f) Putting the catch bucket back down onto a flat surface and continuing to hold the blade vertically; (g) Immediately reusing and pouring the excess mixture from the catch bucket down onto the blade again; (h) Repeating the reusing of material from the catch bucket several times continuously (up to approximately 2 hours); (i) Flipping the blade to the opposite vertical position until the epoxy begins to run down the blade to where the blade is pre-marked and gauged a stopping point; (j) Returning the blade to the previous vertical position until the epoxy tries to drip off of the tip; (k) Flipping blade vertically again; (l) Holding the blade horizontal at times and spinning/rolling the blade to secure a more solid coat and to evenly disperse the color; (m) Brushing the blade with a paint brush for texture; (n) Plugging/attaching the blade into a light sabre hilt with a light and shining the light through an interior of the blade to confirm the even dispersal of the mixture and to check the consistency of the coating process; (o) Curing the mixture; (p) Repeating steps 1 through 13 with another blade as needed.

8. The process of claim 7, wherein the flat surface is selected from the group consisting of a floor, a bench, and a table.

9. The process of claim 7, wherein the curing is in ambient air.

10. The process of claim 7, wherein the curing is in a forced air environment.

11. The process of claim 7, wherein the curing is in a continuous forced air environment.

12. The process of claim 7, wherein the curing is in a heated vessel where the heating method is selected from a group consisting resistance heating, infrared heating, electric or gas forced air.

13. The process of claim 7, wherein the mixing is further comprised of adding a desired and pre-determined amount of reflector enhancer

14. The process of claim 7, wherein the mixing is further comprised of adding a coloring agent.

15. The process of claim 7, wherein the mixing is further comprised of adding a desired amount of glitter onto the coating.

16. The process of claim 7, wherein the spinning is further comprised, when the coating is very thick on the blade and tacky, by brushing with a small brush and lightly touching the epoxy wherein causing the thickened epoxy to pull slightly off of the blade and creating small point and a stringy peak of coating material.
